(19) United States
(12) Patent Application Publication
(10) Pub. No.: US 2012/0315101 A1
(43) Pub. Date: Dec. 13, 2012

(54) THROW-AWAY ROTATING TOOL

(76) Inventors: Jiro Osawa, Toyokawa-City (JP); Tasuku Itoh, Tokokawa-City (JP); Ikuo Takikawa, Toyokawa-City (JP); Takuma Aoyama, Toyokawa-City (JP)

(21) Appl. No.: 12/736,792

(22) PCT Filed: Dec. 8, 2009
(86) PCT No.: PCT/JP09/70567

§ 371 Date: Nov. 8, 2010

(51) Int. Cl. B23B 51/02

(52) U.S. Cl. 408/226

(57) ABSTRACT

A throw-away rotating tool includes at least two grooved portions 13b, 13c formed on each of erected portions 13 and at least two protrusions 26, 27 for fitting into and removal from respective grooved portions 13b, 13c and projected from a projecting coupling portion 23, and the grooved portions 13b, 13c are formed asymmetrically about an axis O and the protrusions 26, 27 are formed asymmetrically about the axis. Thus, the direction in which the projecting coupling portion 23 can be coupled to the erected portions 13 is uniquely determined. Consequently, variations in lip height and run-out can be minimized. As a result, occurrence of a bend and an increase in machined hole diameter during drilling can be prevented, thereby making it possible to minimize variations in machining accuracy and tool life.

### TECHNICAL FIELD

The present invention relates to a throw-away rotating tool, and more particularly to a throw-away rotating tool which can minimize variations in machining accuracy and tool life.

### BACKGROUND ART

A throw-away rotating tool is a tool in which a cutting head having cutting edges is detachably held on a body. In the related art, a throw-away rotating tool is known which includes a fixing portion 120 (projecting coupling portion) projected from the rear end side of a head 100 (cutting head), and plural connecting portions 256A, 256B (erected portions) erected on the distal end of a shank 200 (body) and inside of which the fixing portion 120 (projecting coupling portion) is accommodated (Patent Literature 1). In the throw-away rotating tool disclosed in Patent Literature 1, the connecting portions 256A, 256B (erected portions) include retention walls 269 (grooved portions) recessed in the inner peripheral walls, and the fixing portion 120 (projecting coupling portion) includes plural projections 133 (protrusions) projected from the outer peripheral wall. The projecting coupling portion projected from the rear end side of the cutting head is inserted inside the erected portions of the body, and the cutting head and the body are relatively rotated around the axis to bring the protrusions and the grooved portions into fitting engagement with each other, thereby coupling the projecting coupling portion and the erected portions together. As a result, the cutting head is held on the body.

### CITATION LIST

### Patent Literature

Patent Literature 1: WO 2008/099378 (FIGS. 2 and 7, etc.)

### SUMMARY OF INVENTION

### Technical Problem

In the throw-away rotating tool disclosed in Patent Literature 1, the grooved portions and the protrusions formed in the erected portions and the projecting coupling portion are formed at symmetrical positions about the axis, and the respective sizes and shapes of the protrusions/grooved portions are the same. Therefore, the projecting coupling portion can be coupled to the erected portions in plural directions. Specifically, in the case of the throw-away rotating tool shown in FIGS. 2 and 7 of Patent Literature 1, since two erected portions are erected on the body, the projecting coupling portion can be coupled to the erected portions in two directions.

However, since each individual portion of the cutting head and the body is formed with a predetermined tolerance, depending on the direction in which the projecting coupling portion is coupled to the erected portions, a difference occurs in lip height (difference in height between the cutting edges that are rotating) and run-out (amount of variation of the outer radial position of the cutting head that is rotating) due to the tolerance. That is, since the projecting coupling portion can be coupled to the erected positions in plural directions, the lip height and run-out exhibit plural values. Consequently, variations occur in lip height and run-out. As the lip height and run-out become larger, a bend occurs or the machined hole diameter increases during drilling with the cutting head. Thus, there is a problem in that variations occur in machining accuracy.

Also, since tool life becomes shorter as the lip height and run-out become larger, there is a problem in that due to the ability to couple the projecting coupling portion to the erected portions in plural directions, variations occur in tool life.

The present invention has been made to address the above-described problems, and accordingly its object is to provide a throw-away rotating tool which can minimize variations in machining accuracy and tool life.

### Solution to Problem and Advantageous Effects of Invention

To attain the above object, in a throw-away rotating tool according to claim 1, a projecting coupling portion is inserted inside erected portions and is relatively rotated about the axis to couple the projecting coupling portion and the erected portions together, the throw-away rotating tool includes at least two grooved portions recessed in at least one of the inner peripheral wall of each of the erected portions and the outer peripheral wall of the projecting coupling portion, and at least two protrusions formed so as to allow their fitting into and removal from the respective grooved portions and projected from the other one of the inner peripheral wall of each of the erected portions and the outer peripheral wall of the projecting coupling portion, and the at least two grooved portions are formed asymmetrically about the axis and the at least two protrusions are formed asymmetrically about the axis. Thus, the direction in which the projecting coupling portion can be coupled to the erected portions is uniquely determined. Consequently, variations in lip height and run-out can be minimized. As a result, there is an advantageous effect in that occurrence of a bend and an increase in machined hole diameter during drilling can be prevented, thereby making it possible to minimize variations in machining accuracy. In addition, there is an advantageous effect in that since variations in lip height and run-out can be minimized, variations in tool life can be minimized.

In a throw-away rotating tool according to claim 2, the size, shape, and placement of each of the grooved portions and the protrusions formed in the projecting coupling portion are set so as to position the center of gravity of the cutting head on the axis. Thus, in addition to the advantageous effect provided by the throw-away rotating tool according to claim 1, misalignment of the center of gravity of the cutting head with respect to the axis can be prevented. That is, since the cutting head is formed of a material harder than the body, the specific gravity of the cutting head is larger than the specific gravity of the body. Thus, eccentricity of the throw-away rotating tool can be prevented by preventing eccentricity of the cutting head. As a result, it is possible to prevent occurrence of run-out of the throw-away rotating tool due to eccentricity. Therefore, there is an advantageous effect in that occurrence of a bend and an increase in machined hole diameter during drilling can be prevented, thereby making it possible to improve machining accuracy. In addition, tool life can be improved by minimizing run-out during machining.

In a throw-away rotating tool according to claim 3, the at least two protrusions projected from the projecting coupling portion are formed in the outer peripheral wall of the projecting coupling portion at a uniform angular pitch about the axis, and are formed at different distances from the distal end of the projecting coupling portion, or the at least two grooved portions recessed in the projecting coupling portion are formed in the outer peripheral wall of the projecting coupling portion at a uniform angular pitch about the axis, and are formed at different distances from the distal end of the projecting coupling portion. Thus, in addition to the advantageous effect provided by the throw-away rotating tool according to claim 2, there is an advantageous effect in that by merely making the positions of the protrusions and the grooved portions different in the axial direction, a cutting head whose center of gravity is positioned on the axis can be easily manufactured, thereby enabling an improvement in productivity.

### BRIEF DESCRIPTION OF DRAWINGS

FIG. 1 is a side view of a throw-away rotating tool according to a first embodiment of the present invention.

FIG. 2 is a perspective view of a body of the throw-away rotating tool.

FIG. 3 is a perspective view of a cutting head of the throw-away rotating tool.

FIG. 4(a) is a side view of a projecting coupling portion of the cutting head according to a second embodiment, FIG. 4(b) is a bottom view of the projecting coupling portion, FIG. 4(c) is a side view of a projecting coupling portion of the cutting head according to a third embodiment, FIG. 4(d) is a bottom view of the projecting coupling portion, FIG. 4(e) is a side view of a projecting coupling portion of the cutting head according to a fourth embodiment, and FIG. 4(f) is a bottom view of the projecting coupling portion.

### REFERENCE SIGNS LIST

1 Throw-away rotating tool
10 Body
13 Erected portion
13a Inner peripheral wall
13b, 13c Grooved portion
20 Cutting head
23, 33, 43, 53 Projecting coupling portion
23a, 33a, 43a, 53a Outer peripheral wall
26, 27, 36, 37, 46, 47, 56, 57 Protrusion
O Axis

### DESCRIPTION OF EMBODIMENTS

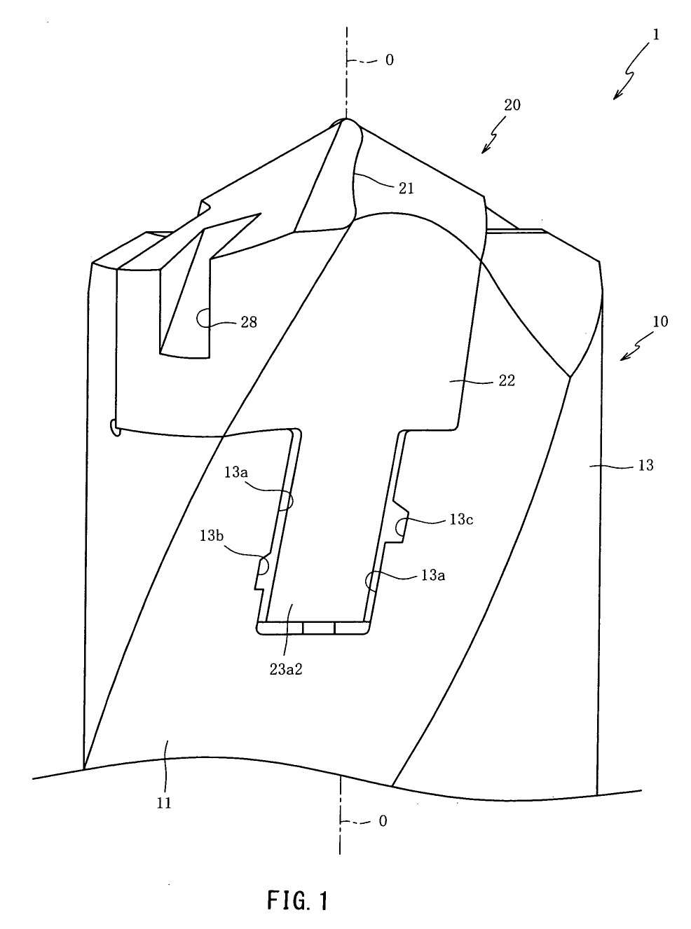

Hereinafter, exemplary embodiments of the present invention will be described with reference to the accompanying drawings. FIG. 1 is a perspective view of a throw-away rotating tool 1 according to a first embodiment of the present invention. It should be noted that in FIG. 1, illustration of the axial length of a body 10 is omitted.

First, referring to FIG. 1, a general configuration of the throw-away rotating tool 1 will be described. As shown in FIG. 1, the throw-away rotating tool 1 includes the body 10, and a cutting head 20 mounted to the body 10. The throw-away rotating tool 1 is a rotating tool to which the rotating force of a processing machine such as a machining center is transmitted via a holder (not shown) that holds the body 10, thereby performing cutting of a workpiece.

The body 10 serves to transmit the rotating force of the processing machine to the cutting head 20, and is made from high speed tool steel into a substantially shaft-like body. One end side of the body 10 is attached to the processing machine via the above-mentioned holder. In this embodiment, a first groove 11 is provided in the outer peripheral surface of the body 10 to discharge chips during cutting.

The cutting head 20 serves to cut a workpiece with cutting edges 21 provided at the distal end. The cutting head 20 is made from cemented carbide harder than the body 10, and is detachably mounted to the body 10. Thus, even when the cutting edges 21 reach their lifetime, cutting can be continued by replacing the cutting head 20 with another tip, without having to grind the cutting head 20 again. In this embodiment, the cutting head 20 is also provided with second grooves 22 for discharging chips during cutting, and the second grooves 22 are connected with the first groove 11 when the cutting head 20 is attached to the body 10. It should be noted that in this embodiment, the cutting head 20 has two cutting edges 21 and two second grooves 22.

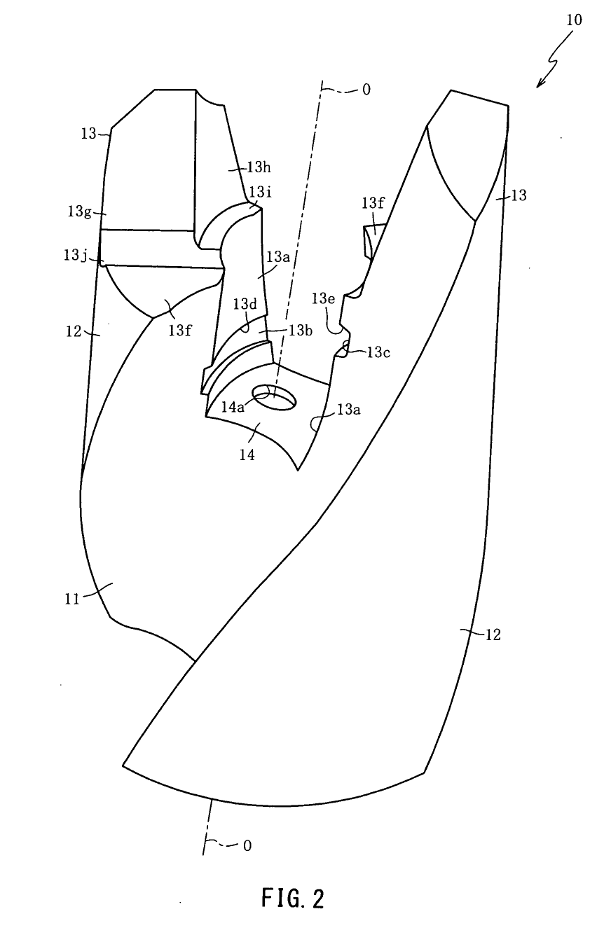

Now, referring to FIG. 2, a detailed configuration of the body 10 will be described. FIG. 2 is a perspective view of the body 10 of the throw-away rotating tool 1. It should be noted that in FIG. 2, illustration of the length in the axial direction of the body 10 is omitted. The body 10 mainly includes plural (two in this embodiment) erected portions 13 which are each extended with a land 12 as its outer peripheral surface and a part of the first groove 11 as its side surface, and erected around an axis O in conformity with the twist angle of the first groove 11, and a bottom portion 14 provided on the rear end portion side of the erected portions 13. The erected portions 13 are portions for holding the cutting head 20, and are erected at a uniform angular pitch (180° in this embodiment) about the axis O. A projecting coupling portion 23 (described later) of the cutting head 20 is inserted inside the erected portions 13. Also, the bottom portion 14 is formed orthogonally to the axis O of the body 10, and has a hole 14a recessed at the central position aligned with the axis O. The hole 14a is a portion in which a projection 23c projected from a rear end portion 23b of the projecting coupling portion 23 (described later) of the cutting head 20 is fitted.

The erected portions 13 have inner peripheral walls 13a each formed as a set of arcuate curves of the same radius centered about the axis O. Grooved portions 13b, 13c are recessed in the respective inner peripheral walls 13a so as to be substantially orthogonal to the axis O. The grooved portion 13b is recessed near the bottom portion 14 of the inner peripheral wall 13a of one of the erected portions 13 (left side in FIG. 2), and the grooved portion 13c is recessed close to the distal end of the inner peripheral wall 13a of the other erected portion 13 (right side in FIG. 2). That is, the grooved portions 13b, 13c are formed at different distances from the distal ends of the corresponding inner peripheral walls 13a. Also, the grooved portions 13b, 13c have wall portions 13d, 13e opposed to the bottom portion 14, respectively. Since the grooved portions 13b, 13c are formed in the inner peripheral walls 13a of the erected portions 13 as described above, the thickness (wall thickness) of the erected portions 13 can be reduced by an amount corresponding to the thickness of each of the grooved portions 13b, 13c. Thus, the amount of elastic deformation of the erected portions 13 which tilt outwards (in a direction away from the axis O) can be increased, allowing for easy insertion and removal of the projecting coupling portion 23 (described later) of the cutting head 20, and also the force with which the cutting head 20 is held by the erected portions 13 can be increased.

The erected portions 13 each have a first surface 13f provided on the distal end side of the erected portions 13 and on the forward side of rotation of the body 10 at the time of cutting. The first surface 13f is substantially orthogonal to the axis O and formed substantially parallel to the bottom portion 14. A torque transmission wall 13g forming a substantially perpendicular or acute angle to the first surface 13f is erected on the first surface 13f on the backward side of rotation of the body 10 at the time of cutting. The width of the torque transmission wall 13g is formed slightly narrower than the width of the first surface 13f with respect to the direction of rotation of the body 10 at the time of cutting.

An inner peripheral wall step surface 13h is a portion crossing the torque transmission wall 13g via a ridge line, and is formed on the distal end side of each of the erected portions 13 in conformity with the twist angle of the first groove 11 as a set of arcuate curves of the same radius centered about the axis O. It should be noted that the radius of the inner peripheral wall step surface 13h about the axis O is configured to be larger than the radius of the inner peripheral walls 13a. As a result, the inner wall step surface 13h is connected to each of the inner peripheral walls 13a through a second surface 13i that is extended from the first surface 13f on the same plane as the first surface 13f.

Here, a recess 13j is formed along the width direction of the first surface 13f at the portion where the first surface 13f and the torque transmission wall 13g cross. The presence of the recess 13j at the portion where the first surface 13f and the torque transmission wall 13g cross facilitates surface machining such as grinding of the first surface 13f and the torque transmission wall 13g, thus enabling improved productivity. Also, the first surface 13f has a downward sloping taper formed on the side opposite to the torque transmission wall 13g. This allows a first receiving portion 25 (described later) of the cutting head 20 to be slid into contact with the first surface 13f without abutting against the first surface 13f when attaching the cutting head 20.

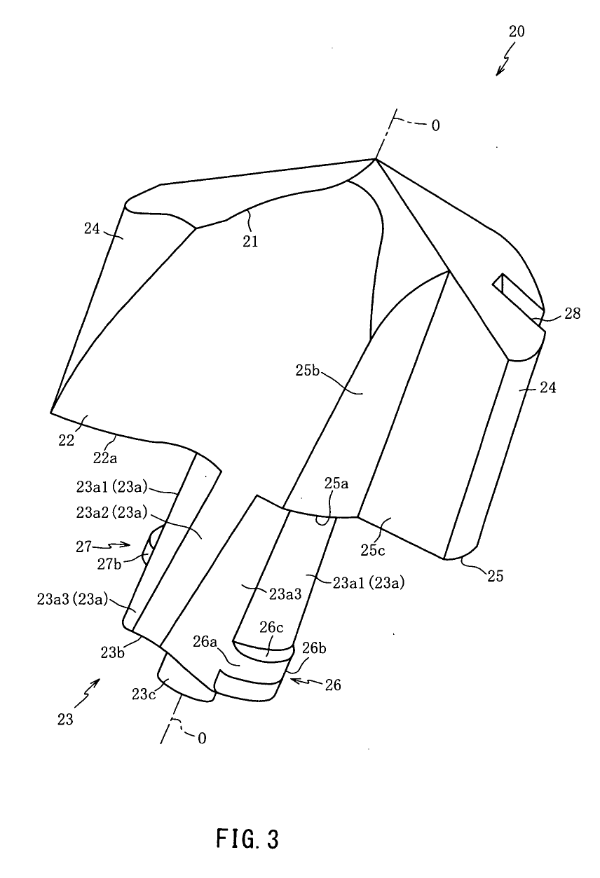

Next, referring to FIG. 3, a detailed configuration of the cutting head 20 will be described. FIG. 3 is a perspective view of the cutting head 20 of the throw-away rotating tool 1. As shown in FIG. 3, the cutting head 20 mainly includes the cutting edges 21 provided at the distal end, and the projecting coupling portion 23 having a shaft-like shape projected from the rear end (side opposite to the side where the cutting edges 21 are provided) coaxially with the axis O.

An outer peripheral wall 23a of the projecting coupling portion 23 includes an outer peripheral wall sliding contact portion 23a1 and an outer peripheral wall grooved portion 23a2 which are provided around the axis O. The outer peripheral wall sliding contact portion 23a1 is bowed outwards in a direction orthogonal to the axis O, and contacts at least a part of the inner peripheral walls 13a of the erected portions 13 of the body 10. The outer peripheral wall grooved portion 23a2 has an outer edge formed in a part of or inside an edge portion 22a of each of the second grooves 22 of the cutting head 20 as seen in plan view (as viewed from the direction of the axis O). A chamfered portion 23a3 is formed at the portion of the ridge line connecting between the outer peripheral wall sliding contact portion 23a1 and the outer peripheral wall grooved portion 23a2. Since at least a part of the outer peripheral wall sliding contact portion 23a1 contacts the inner peripheral walls 13a of the erected portions 13 of the body 10 (see FIG. 2), the outer peripheral wall sliding contact portion 23a1 of the projecting coupling portion 23 is held between the inner peripheral walls 13a of the erected portions 13.

Also, in plan view, the outer edge of the outer peripheral wall grooved portion 23a2 is formed in the same plane as the edge portion 22a of each of the second grooves 22 of the cutting head 20, or on the axis O side with respect to the edge portion 22a. Thus, as shown in FIG. 1, it is possible to prevent the outer peripheral wall grooved portion 23a2 from projecting from the first groove 11 of the body 10 upon coupling the cutting head 20 and the body 10 together. Consequently, the throw-away rotating tool 1 enables smooth discharge of chips from the second grooves 22 and the first groove 11. Further, the formation of the chamfered portion 23a3 in the projecting coupling portion 23 allows for smooth relative rotation when attaching the body 11 and the cutting head 20 together.

The cutting head 20 has a first receiving portion 25 provided on the distal end side (side opposite to the rear end portion 23b) of the projecting coupling portion 23 and at a position shifted by the twist angle of the first groove 11 and the second grooves 22. The first receiving portion 25 is projected from the outer peripheral wall 23a in a direction orthogonal to the axis O and crosses a land 24. Also, protrusions 26, 27 are projected from the outer peripheral wall sliding contact portion 23a1 of the projecting coupling portion 23 across the circumferential direction of the outer peripheral wall sliding contact portion 23a1.

The protrusion 26 is projected from the rear end portion 23b side of the projecting coupling portion 23, and the protrusion 27 is projected from the distal end side (side opposite to the rear end portion 23b) of the projecting coupling portion 23. The protrusion 26 and the protrusion 27 are portions that are fitted in the grooved portion 13b and the grooved portion 13c recessed in the inner peripheral walls 13a of the erected portions 13 of the body 10 (see FIG. 2), respectively. It should be noted that the protrusions 26, 27 are formed in the same shape and the same size.

The protrusion 26 is configured to include a first inclined portion 26a and a second inclined portion 26b which are located on the forward side of rotation of the cutting head 20 and on the rearward side of rotation of the cutting head 20 when attaching the cutting head 20 to the body 10, respectively. The first inclined portion 26a and the second inclined portion 26b are formed in a curved shape that is inclined downwards toward the axis O. The provision of the first inclined portion 26a in the protrusion 26 enables smooth insertion of the protrusion 26 into the grooved portion 13b when attaching the cutting head 20 to the body 10 (see FIG. 2). Also, the provision of the second inclined portion 26b enables smooth removal of the protrusion 26 from the grooved portion 13b when detaching the cutting head 20 from the body 10. It should be noted that the protrusion 27 is also configured to include a first inclined portion 27a (not shown) and a second inclined portion 27b, and the same operation can be obtained.

Also, the protrusion 26 includes a third inclined portion 26c formed by the wall surface on the distal end side (side opposite to the rear end portion 23c) of the projecting coupling portion 23 being inclined downwards toward the axis O. Since the protrusion 26 includes the third inclined portion 26c, upon fitting the protrusion 26 into the grooved portion 13b of the erected portions 13 (see FIG. 2), the wall portion 13d of the grooved portion 13b is pressed against the third inclined portion 26c, causing the erected portions 13 to undergo elastic deformation and tilt slightly to the outer peripheral side, and the resulting reaction force causes the projecting coupling portion 23 to be stably held inside the erected portions 13. It should be noted that likewise, the protrusion 27 is configured to include a third inclined portion 27c (not shown), and the same operation can be obtained.

Here, the distance from the third inclined portion 26c of the protrusion 26 to the first receiving portion 25 in the direction parallel to the axis O is set to be substantially the same as the distance from the wall portion 13d of the grooved portion 13b of the body 10 (see FIG. 2) to the first surface 13f in the direction parallel to the axis O. Thus, when the protrusion 26 is slid and fitted in the grooved portion 13b of the body 10, and the third inclined portion 26c of the protrusion 26 contacts the wall portion 13d of the grooved portion 13b, the first receiving portion 25 can come into contact with the first surface 13f of the body 10.

The projecting coupling portion 23 has the projection 23c projected from the center of the rear end portion 23b. The projection 23c is inserted into the hole 14a recessed in the bottom portion 14 upon inserting the projecting coupling portion 23 inside the erected portions 13 of the body 10 (see FIG. 2) in a phase-shifted state. Thus, when attaching and detaching the cutting head 20 to and from the body 10, the body 10 and the cutting head 20 can be relatively rotated around the axis O about the hole 14a and the projection 23c.

The cutting head 20 also includes a second receiving portion 25a extended from the first receiving portion 25 on the same plane as the first receiving portion 25. The second receiving portion 25a is a portion that is projected from the outer peripheral wall sliding contact portion 23a1 of the projecting coupling portion 23 in a direction orthogonal to the axis O, and comes into contact with the second surface 13i of the body 10 (see FIG. 2). The first receiving portion 25 and the second receiving portion 25a are formed at predetermined positions on the cutting head 20 so as to be rotationally symmetrical about the axis O.

An outer peripheral wall step portion 25b is a portion whose distance from the axis O is set larger than the distance from the axis O to the outer peripheral wall sliding contact portion 23a1 and smaller than the distance from the axis O to the land 24, and which crosses the second receiving portion 25a. Also, the outer peripheral wall step portion 25b is a portion which at least partially contacts the inner peripheral wall step portion 13h of each of the erected portions 13 of the body 10 (see FIG. 2). Thus, the outer peripheral wall step portion 25b is held between the inner peripheral wall step portions 13h of the erected portions 13 of the body 10. Also, a transmission wall receiving portion 25c forming a substantially perpendicular angle or acute angle to the first receiving portion 25 is erected on the outer peripheral wall step portion 25b on the forward side of rotation of the cutting head 20 at the time of cutting. The transmission wall receiving portion 25c is a portion that contacts the torque transmission wall 13g of the body 10 (see FIG. 2).

As described above, the projecting coupling portion 23 includes the protrusions 26, 27 that are formed at a uniform angular pitch (180° in this embodiment) about the axis O, and are each projected from the outer peripheral wall sliding contact portion 23a1 in a direction away from the axis O. Also, the distances from the distal end (side opposite to the rear end portion 23b) of the projecting coupling portion 23 to the respective third inclined portions 26c, 27c of the protrusions 26, 27 are set to the same as the distances from the first surface 13f and second surface 13i of the body 10 (see FIG. 2) to the wall portions 13d, 13e of the grooved portions 13b, 13c. Therefore, the protrusions 26, 27 can be fitted in the grooved portions 13b, 13c, respectively.

When attaching the cutting head 20 to the body 10 (see FIG. 2), the projecting coupling portion 23 of the cutting head 20 is inserted inside the erected portions 13 in a phase-shifted state. Next, an unillustrated replacement tool is inserted into an outer peripheral groove 28 formed at an edge of the distal end of the cutting head 20, and the replacement tool is gripped and the cutting head 20 and the body 10 are relatively rotated, thereby fitting the protrusions 26, 27 into the grooved portions 13b, 13c. The relative rotation between the body 10 and the cutting head 20 is performed until the transmission wall receiving portion 25c of the cutting head 20 abuts on the torque transmission wall 13g of the body 10. Thus, the projecting coupling portion 23 of the cutting head 20 is held between the erected portions 13. Also, when performing drilling, rotational torque transmitted to the body 10 is transmitted to the cutting head 20 via the torque transmission wall 13g and the transmission wall receiving portion 25c.

Here, the protrusions 26, 27 are formed at different distances from the distal end of the projecting coupling portion 23, and the grooved portions 13b, 13c (see FIG. 2) are formed at different distances from the first surface 13f and second surface 13i of each of the erected portions 13. Therefore, the protrusion 26 is fitted only in the grooved portion 13b, and the protrusion 27 is fitted only in the grooved portion 13c. As a result, the direction in which the projecting coupling portion 23 can be coupled to the erected portions 13 is uniquely determined. Thus, variations in the lip height and run-out of the throw-away rotating tool 1 can be minimized. As a result, occurrence of a bend and an increase in machined hole diameter during drilling can be prevented, thereby making it possible to minimize variations in machining accuracy. In addition, since variations in lip height and run-out can be minimized, variations in tool life can be minimized.

Also, the two protrusions 26, 27 are formed in the same size and shape, and are projected from the outer peripheral wall 23a of the projecting coupling portion 23 at a uniform angular pitch about the axis O. The two protrusions 26, 27 only differ in their position with respect to the axial direction of the projecting coupling portion 23. Thus, the centers of gravity of the protrusions 26, 27 and the projecting coupling portion 23 are set so as to be positioned on the axis O. As a result, misalignment of the center of gravity of the cutting head 20 with respect to the axis O can be prevented. Since the specific gravity of the cutting head 20 formed of a material harder than the body 10 is larger than the specific gravity of the body 10, eccentricity of the throw-away rotating tool 1 can be prevented by preventing eccentricity of the cutting head 20. Therefore, it is possible to prevent occurrence of run-out of the throw-away rotating tool 1 due to eccentricity, thereby preventing occurrence of a bend and an increase in machined hole diameter during drilling. Hence, machining accuracy can be improved, and also tool life can be improved by minimizing run-out during machining.

Further, the protrusions 26, 27 projected from the projecting coupling portion 23 are formed in the outer peripheral wall 23a of the projecting coupling portion 23 at a uniform angular pitch about the axis O, and are formed at different distances from the distal end of the projecting coupling portion 23. Thus, it is easy to manufacture the cutting head 20 whose center of gravity is positioned on the axis O. It is thus possible to improve productivity for the throw-away rotating tool 1.

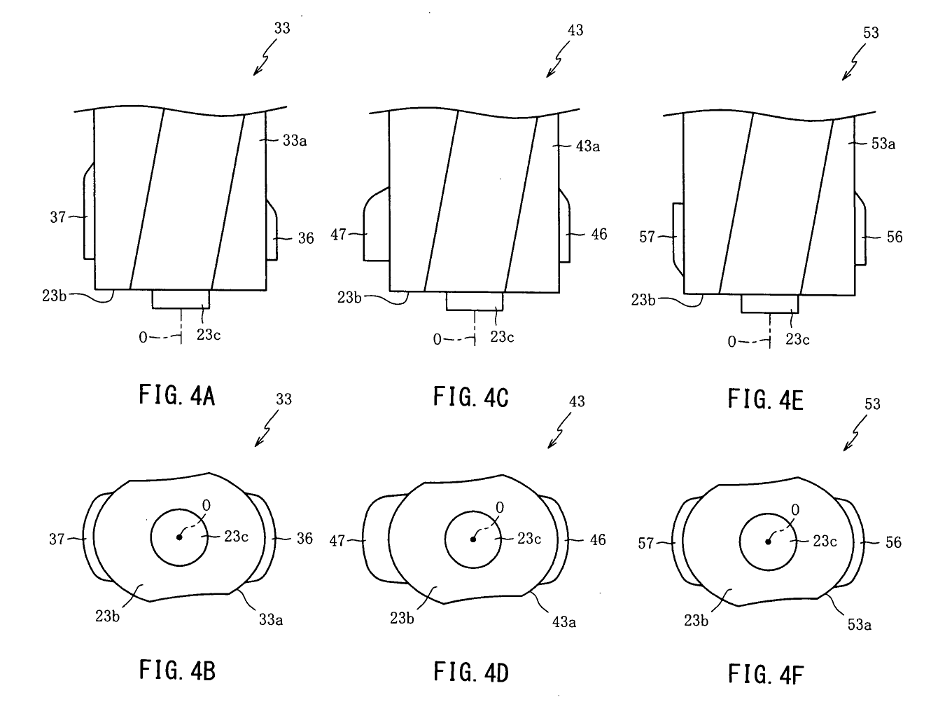

Next, referring to FIG. 4, a throw-away rotating tool according to a second embodiment, a third embodiment, and a fourth embodiment will be described. The first embodiment is directed to the case in which the protrusions 26, 27 projected from the projecting coupling portion 23 of the cutting head 20 are the same in size and shape, and are different in distance (different in their placement) from the distal end of the projecting coupling portion 23. In contrast, the second embodiment, the third embodiment, and the fourth embodiment are each directed to the case of a throw-away rotating tool in which protrusions 36, 37, 46, 47, 56, 57 projected from a projecting coupling portion 33, 43, 53 are different in size and shape. It should be noted that in FIG. 4, a part (the rear end portion 23b side) of the projecting coupling portion 33, 43, 53 of the cutting head is shown, and the distal end side of the projecting coupling portion 33, 43, 53 is not shown. Also, portions that are the same as those in the first embodiment are denoted by the same symbols, and description thereof is omitted.

FIG. 4(a) is a side view of the projecting coupling portion 33 of the cutting head according to the second embodiment. FIG. 4(b) is a bottom view of the projecting coupling portion 33. FIG. 4(c) is a side view of the projecting coupling portion 43 of the cutting head according to the third embodiment. FIG. 4(d) is a bottom view of the projecting coupling portion 43. FIG. 4(e) is a side view of the projecting coupling portion 53 of the cutting head according to the fourth embodiment. FIG. 4(f) is a bottom view of the projecting coupling portion 53.

The protrusions 36, 37 of the projecting coupling portion 33 according to the second embodiment shown in FIG. 4(a) and FIG. 4(b) are formed in an outer peripheral wall 33a of the projecting coupling portion 33 at a uniform angular pitch about the axis O. The protrusion 37 is formed with a length in the axial direction longer than the length in the axial direction of the protrusion 36. Although a body including erected portions to be coupled to the projecting coupling portion 33 is not shown, as described with regard to the first embodiment, grooved portions with which the protrusions 36, 37 are to be fitted are formed in the erected portions. Thus, in the second embodiment, as in the first embodiment, the direction in which the projecting coupling portion 33 can be coupled to the unillustrated erected portions is uniquely determined. Thus, the same operation as that in the first embodiment can be obtained.

The protrusions 46, 47 of the projecting coupling portion 43 according to the third embodiment shown in FIG. 4(c) and FIG. 4(d) are formed in an outer peripheral wall 43a of the projecting coupling portion 43 at a uniform angular pitch about the axis O. While the lengths in the axial direction of the protrusions 46, 47 are the same, the protrusion 47 is formed so as to be larger in the amount of projection from the outer peripheral wall 43a than the protrusion 46. Although a body including erected portions to be coupled to the projecting coupling portion 43 is not shown, as described with regard to the first embodiment, grooved portions with which the protrusions 46, 47 are to be fitted are formed in the erected portions. Thus, in the third embodiment, as in the first embodiment, the direction in which the projecting coupling portion 43 can be coupled to the unillustrated erected portions is uniquely determined. Thus, the same operation as that in the first embodiment can be obtained.

The protrusions 56, 57 of the projecting coupling portion 53 according to the fourth embodiment shown in FIG. 4(e) and FIG. 4(f) are formed in an outer peripheral wall 53a of the projecting coupling portion 53 at a uniform angular pitch about the axis O. Although the protrusions 56, 57 are formed to be the same in their length in the axial direction and amount of projection from the outer peripheral wall 53a, the protrusions 56, 57 are formed in different shapes. That is, while the protrusion 57 is formed by the wall surface on the rear end portion 23b side being inclined downwards toward the axis O, the protrusion 56 is formed by the wall surface on the distal end side (side opposite to the rear end portion 23b) being inclined downwards toward the axis O. Although a body including erected portions to be coupled to the projecting coupling portion 33 is not shown, as described with regard to the first embodiment, grooved portions with which the protrusions 56, 57 are to be fitted are formed in the erected portions. Thus, in the fourth embodiment, as in the first embodiment, the direction in which the projecting coupling portion 53 can be coupled to the unillustrated erected portions is uniquely determined. Thus, the same operation as that in the first embodiment can be obtained. Furthermore, since the protrusions 56, 57 are only different in shape, the centers of gravity of the protrusions 56, 57 and the projecting coupling portion 53 are set so as to be positioned on the axis O. As a result, eccentricity of the throw-away rotating tool can be prevented. Therefore, it is possible to prevent run-out from occurring during drilling, thereby preventing occurrence of a bend and an increase in machined hole diameter.

### EXAMPLES

Hereinbelow, an example representing further concrete implementation of the present invention will be described. However, the present invention is not to be limited by the following example.

The run-out and lip height of the throw-away rotating tool configured as in the first embodiment mentioned above (hereinafter, referred to as “product of the present invention”) were measured. The run-out was obtained with respect to the product of the present invention by attaching the cutting head to the body, followed by rotation with reference to the body, and measuring the amount of swing of the margin near the outer peripheral corner by using a dial gauge. After the measurement, the cutting head was detached from the body and then the same cutting head was attached to the body, and the run-out was measured in the same manner using the dial gauge. This was repeated 20 times, and 20 measured values were obtained.

The lip height was obtained with respect to the product of the present invention by attaching the cutting head to the body, and then measuring the difference in height between the cutting edges after rotation about the axis, by using the dial gauge. After the measurement, the cutting head was detached from the body and then the same cutting head was attached to the body, and the lip height was measured in the same manner using the dial gauge. This was repeated 20 times, and 20 measured values were obtained.

Also, for comparison, run-out and lip height were measured in the same way with respect to the throw-away rotating tool according to the related art disclosed in Patent Literature 1 (one in which the grooved portions and the protrusions formed in the erected portions and the projecting coupling portion are formed at symmetrical positions about the axis, and the respective sizes and shapes of the protrusions/grooved portions are the same) (hereinafter, referred to as “product of the related art”).

It should be noted that in the product of the related art, the grooved portions and the protrusions are in symmetrical relation about the axis, so the cutting head can be attached to the body from two directions. Accordingly, after 10 measured values were obtained by attaching the cutting head to the body from one direction, 10 measured values were obtained by attaching the cutting head to the body from the other direction, thereby obtaining 20 measured values.

It should be noted that the dimensions of individual portions of the product of the present invention are as follows: the diameter of the cutting head and the body is 16 mm, the point angle of the cutting head is 140°, the length in the axial direction of the projecting coupling portion is 6 mm, the diameter of the outer peripheral wall sliding contact portion is 6 mm, the length in the axial direction of the protrusions is 1 mm, and the height in the radial direction of the protrusions is 0.5 mm. Also, the two protrusions are formed at different distances in the axial direction from the distal end of the projecting coupling portion, such that the length in the axial direction from the distal end of the projecting coupling portion to one of the protrusions is 2.5 mm and the length in the axial direction from the distal end of the projecting coupling portion to the other of the protrusions is 4 mm.

Also, in the product of the related art, the two protrusions are formed with the axis as the center of symmetry, their distances in the axial direction from the distal end of the projecting coupling portion are both 4 mm, and dimensions of other portions are set to the same as those of the product of the present invention.

From 20 measured values of run-out and lip height of each of the product of the present invention and the product of the related art configured as described above, average values (AVG), maximum values (MAX), minimum values (MIN), and standard deviations (σ) were calculated. The results are shown in Table 1.

TABLE 1

| | |
|---|---|
| Run-out (μm) | Lip height (μm) |

| | Product of | | Product of | |
|---|---|---|---|---|
| | present | Product of | present | Product of |
| | invention | related art | invention | related art |
| AVG | 12.8 | 13.6 | 1.6 | 3.3 |
| MAX | 16.2 | 24.8 | 3.2 | 6.1 |
| MIN | 8.5 | 4.3 | 0.5 | 0.5 |
| σ | 1.8 | 5.9 | 0.7 | 1.5 |

From Table 1, it was found that as compared with the product of the related art, the product of the present invention can reduce the standard deviations, that is, variations of run-out and lip height. Whether this is a significant difference or not was tested on both sides, and it was successfully concluded that both are significant at 5% level. As a result, it became evident that according to the product of the present invention, variations in run-out and lip height can be minimized.

The present invention has been described above with reference to the embodiments. However, the present invention is by no means limited to the above embodiments, but it can be easily anticipated that various improvements and modifications are possible without departing from the scope of the present invention. For example, numerical values recited in the above embodiments (for example, the quantities and dimensions of individual components) are merely illustrative, and other numerical values can be adopted of course.

While each of the above embodiments is directed to the case in which the body 10 is made of high speed tool steel, and the cutting head 20 is made of a cemented carbide, the present invention is not limited to these. It is also possible to adopt other materials. As for such other materials, for example, the body 10 can be made of an alloy tool steel, and the cutting head 20 can be made of cermet, superfine particle cemented carbide, coated cemented carbide, or the like.

While each of the above embodiments is directed to the case of a twist drill with the first groove 11 and the second grooves 22 formed at a predetermined twist angle with respect to the axis O, the present invention is not necessarily limited to this, but can be applied to a straight drill in which the first groove 11 and the second grooves 22 are parallel to the axis O. Also, the present invention can be applied to a throw-away rotating tool with no grooves formed in the body 10.

While each of the above embodiments is directed to the case in which the distance between the inner peripheral walls 13a of the erected portions 13 and the axis O is constant across the height direction of the inner peripheral walls 13a, the present invention is not necessarily limited to this. It is also possible to set the distance so as to gradually increase along the height direction of the inner peripheral walls 13a, or gradually decrease along the height direction of the inner peripheral walls 13a. In these cases, the thickness of the projecting coupling portion 23, 33, 43, 53 is adjusted in accordance with the size of the inner peripheral walls 13a so that the projecting coupling portion 23, 33, 43, 53 of the cutting head 20 comes into contact with the inner peripheral walls 13a. This is because in the throw-away rotating tool 1 according to the present invention, since the cutting head 20 is fixed to the body 10 by the protrusions 25, 26, 36, 37, 46, 47, 56, 57 of the cutting head 20 being fitted into the grooved portions 13a of the body 10, as long as the projecting coupling portion 23, 33, 43, 53 can be held on the inner peripheral walls 13a without backlash, the sizes in the height direction of the inner peripheral walls 13a and the projecting coupling portion 23, 33, 43, 53 do not affect the fixation of the cutting head 20. Likewise, it is also possible to set the inside diameter so as to gradually increase or gradually decrease in the height direction of the inner peripheral wall step portion 13h.

While each of the above embodiments is directed to the case in which the grooved portions 13b, 13c are recessed in the erected portions 13 of the body 10 and the protrusions 26, 27, 36, 37, 46, 47, 56, 57 are projected from the projecting coupling portion 23, 33, 43, 53 of the cutting head 20, the present invention is not necessarily limited to this. Conversely to these embodiments, the protrusions 26, 27, 36, 37, 46, 47, 56, 57 can be projected from the erected portions 13, and the grooved portions 13b, 13c can be recessed in the projecting coupling portion 23, 33, 43, 53. Also, it is possible to form protrusions and grooved portions in the erected portions 13, and form grooved portions and protrusions that come into fitting engagement with those in the projecting coupling portion. In these cases as well, the same operation can be obtained.

While each of the above embodiments is directed to the case in which the second surface 13i is formed in the body 10, and the second receiving portion 25a is formed in the cutting head 20, the present invention is not necessarily limited to this. It is also possible to provide neither the second surface 13i nor the second receiving portion 25a. In this case as well, the rotating force of a processing machine such as a machining center can be transmitted to the cutting head 20 via the body 10 by means of contact between the torque transmission wall 13g of the body 10 and the transmission wall receiving portion 25c of the cutting head 20. In addition, the cutting head 20 can be firmly fixed to the body 10 by means of contact between the first surface 13f of the body 10 and the first receiving portion 25 of the cutting head 20.

While each of the above embodiments is directed to the throw-away rotating tool having the cutting edges 21 formed at two locations at the distal end of the cutting head 20, the present invention is not necessarily limited to this. It is also possible to use the cutting head having cutting edges formed at three or more locations, and the body. In this case, it is possible to set the number of the erected portions of the body to three or more as appropriate, and provide a grooved portion for each of the erected portions.

While each of the above embodiments is directed to the case in which the hole 14a is formed in the bottom portion 14 of the body 10, and the projection 23c to be fitted in the hole 14a is formed in the cutting head 20, the present invention is not necessarily limited to this. In some cases, the hole 14a and the projection 23c are not provided.

Although not described in each of the above embodiments, it is preferable to mark the body 10 and the cutting head 20 with an impression, a marking, or the like indicating the attaching direction of the cutting head 20. This is because since the worker can easily recognize the attaching direction of the cutting head 20, the ease of attachment can be improved.

1. A throw-away rotating tool comprising: a body having a plurality of erected portions erected around an axis at an interval from each other; and a cutting head made from a material harder than the body and having a projecting coupling portion projected from a rear end, the projecting coupling portion being inserted inside the erected portions and relatively rotated around the axis to couple the projecting coupling portion and the erected portions together, wherein the throw-away rotating tool includes
at least two grooved portions recessed in at least one of an inner peripheral wall of each of the erected portions and an outer peripheral wall of the projecting coupling portion, and
at least two protrusions formed so as to allow their fitting into and removal from the respective grooved portions and projected from at least one of the inner peripheral wall of each of the erected portions and the outer peripheral wall of the projecting coupling portion, and
wherein the at least two grooved portions are formed asymmetrically about the axis, and the at least two protrusions are formed asymmetrically about the axis.

2. The throw-away rotating tool according to claim 1, wherein a size, a shape, and placement of each of the grooved portions and the protrusions formed in the projecting coupling portion are set so as to position a center of gravity of the cutting head on the axis.

3. The throw-away rotating tool according to claim 2, wherein the at least two protrusions projected from the projecting coupling portion are formed in the outer peripheral wall of the projecting coupling portion at a uniform angular pitch about the axis, and are formed at different distances from a distal end of the projecting coupling portion, or the at least two grooved portions recessed in the projecting coupling portion are formed in the outer peripheral wall of the projecting coupling portion at a uniform angular pitch about the axis, and are formed at different distances from the distal end of the projecting coupling portion.
